(19) United States
(12) Patent Application Publication
(10) Pub. No.: US 2010/0239260 A1
(43) Pub. Date: Sep. 23, 2010

(54) OPTICAL TRANSMISSION APPARATUS, OPTICAL COMMUNICATION METHOD, AND OPTICAL COMMUNICATION SYSTEM

(75) Inventors: Yasushi OIKAWA, Kawasaki (JP); Akira Sugiyama, Kawasaki (JP); Izumi Yokota, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/725,820

(22) Filed: Mar. 17, 2010

(30) Foreign Application Priority Data
Mar. 19, 2009 (JP) 2009-68008

(51) Int. Cl. H04J 14/02

(52) U.S. Cl. 398/81

(57) ABSTRACT

An optical transmission apparatus and method thereof is provided. The optical transmission apparatus includes transmission units configured to transmit lights having different wavelengths, a multiplexing unit configured to multiplex lights transmitted from the transmission units, and a controller configured to control wavelengths of the lights, where the controller includes a wavelength spacing processing unit that controls a spacing between the wavelengths on the basis of reception state information of an apparatus that has received the multiplexed light.

### CROSS-REFERENCE TO RELATED APPLICATIONS

This application is based upon and claims the benefit of priority of the prior Japanese Patent Application No. 2009-068008, filed on Mar. 19, 2009, the entire contents of which are incorporated herein by reference.

### FIELD

The embodiments discussed herein are related to an optical transmission apparatus, an optical communication method, and an optical communication system. Optical transmission apparatuses, optical communication methods, and optical communication systems, for example, include a wavelength division multiplexing (WDM)-based optical transmission apparatus, optical communication method, and optical communication system.

### BACKGROUND

Generally, in a WDM-based optical communication system, a frequency grid in which optical frequencies are arranged at a fixed spacing relative to a reference frequency, has been hitherto recommended by International Telecommunications Union Telecommunications Standardization Sector (ITU-T). In general, wavelengths of multiplied light are arranged in accordance with this frequency grid. According to the ITU-T, as an optical frequency spacing in a dense WDM (high density wavelength division multiplexing; DWDM) scheme, 200 GHz, 100 GHz, 50 GHz, or 25 GHz is recommended. On the other hand, as an optical frequency spacing in the coarse WDM (low density wavelength division multiplexing; CWDM) scheme, 20 nm is recommended as an optical wavelength spacing. For example, an optical transmission system in which optical signals of 10 Gbits/s and 40 Gbits/s are arranged on a frequency grid (or wavelength grid) with a spacing of 25 GHz have been discussed (refer to, for example, Japanese Laid-open Patent Publication No. 2006-86920). Here, the “frequency grid” refers to a spectrum grid in which the center of the spectrum of each optical signal is expressed in terms of a frequency, while the “wavelength grid” refers to a spectrum grid in which the center of the spectrum of each optical signal is expressed in terms of a wavelength.

### SUMMARY

According to an aspect of an embodiment, an optical transmission apparatus and method thereof are provided. The optical transmission apparatus includes transmission units configured to transmit lights having different wavelengths, a multiplexing unit configured to multiplex lights transmitted from the transmission units, and a controller configured to control wavelengths of the lights, where the controller includes a wavelength spacing processing unit that controls a spacing between the wavelengths on the basis of reception state information of an apparatus that has received the multiplexed light.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram of a configuration of an optical communication system in an embodiment;

FIG. 2 is a flowchart illustrating a procedure for wavelength arrangement processing in an embodiment;

FIG. 3 is a block diagram of a configuration of an optical communication system in an embodiment;

FIG. 4 is a block diagram of a configuration of an optical transmission apparatus in an embodiment;

FIG. 5 is a block diagram of another configuration of the optical transmission apparatus in an embodiment;

FIG. 6 is a block diagram of still another configuration of the optical transmission apparatus in an embodiment;

FIG. 7 is a block diagram of a configuration of an transmission unit in an embodiment;

FIG. 8 is a block diagram of a configuration of a controller in an embodiment;

FIG. 9 is a block diagram of a configuration of an optical reception apparatus in an embodiment;

FIG. 10 is a block diagram of a configuration of a reception unit in an embodiment;

FIG. 11 is an explanatory diagram illustrating characteristics of a optical filter in an embodiment;

FIG. 12 is a flowchart illustrating a procedure for wavelength arrangement processing in an embodiment;

FIG. 13 is an explanatory diagram illustrating examples of wavelength arrangements in an embodiment;

FIG. 14 is an explanatory diagram illustrating an example of wavelength arrangement in an embodiment;

FIG. 15 is an explanatory diagram illustrating an example of wavelength arrangement in an embodiment;

FIG. 16 is a flowchart illustrating a measurement processing procedure for characteristics in an embodiment;

FIG. 17 is a graph illustrating an example of a relationship between Q values and dispersion compensation values in an embodiment;

FIG. 18 is a graph illustrating an example of a relationship between Q values and PE values in an embodiment;

FIG. 19 is a table illustrating an example of measurement data of the relationship between Q values and dispersion compensation values in an embodiment;

FIG. 20 is a graph illustrating an example of a relationship between Q values and wavelength spacings in an embodiment; and

FIG. 21 is a table illustrating an example of measurement data on relationship between Q values and wavelength spacings in an embodiment.

### DESCRIPTION OF EMBODIMENT(S)

Reference will now be made in detail to the embodiments, examples of which are illustrated in the accompanying drawings, wherein like reference numerals refer to the like elements throughout. The embodiments are described below to explain the present invention by referring to the figures.

In general, transmission quality of optical communications is not uniform over the entire wavelength band, but has wavelength dependence. Hence, when multiplexing lights mutually different in wavelength, the optimum wavelength spacing may vary in accordance with the wavelength. Furthermore, in a wavelength band high in the transmission quality, even if optical signals are arranged at a spacing narrower than the wavelength (frequency) recommended by the ITU-T, a desired transmission quality may be able to be ensured. However, in typical optical communication systems, since wavelengths are uniformly arranged over the entire band at a spacing just as recommended by the ITU-T, a problem occurs in that the transmission capacity of a system cannot be increased.

Moreover, when multiplexing lights (optical signals) mutually different in modulation method or in bit rate, the optimum wavelength spacing may vary in accordance with the modulation method or the bit rate. However, in typical optical communication systems, the wavelength spacing is determined in the design stage, and may not be changed later. For this reason, when a system with a wavelength spacing different from that in the design stage becomes necessary in future, a lot of time and effort are required to remodel the existing optical transmission apparatus, or to design an optical transmission apparatus corresponding to a new wavelength spacing.

Hereinafter, embodiments of the optical transmission apparatus, the optical communication method, and the optical communication system will be described in detail with reference to the appended drawings.

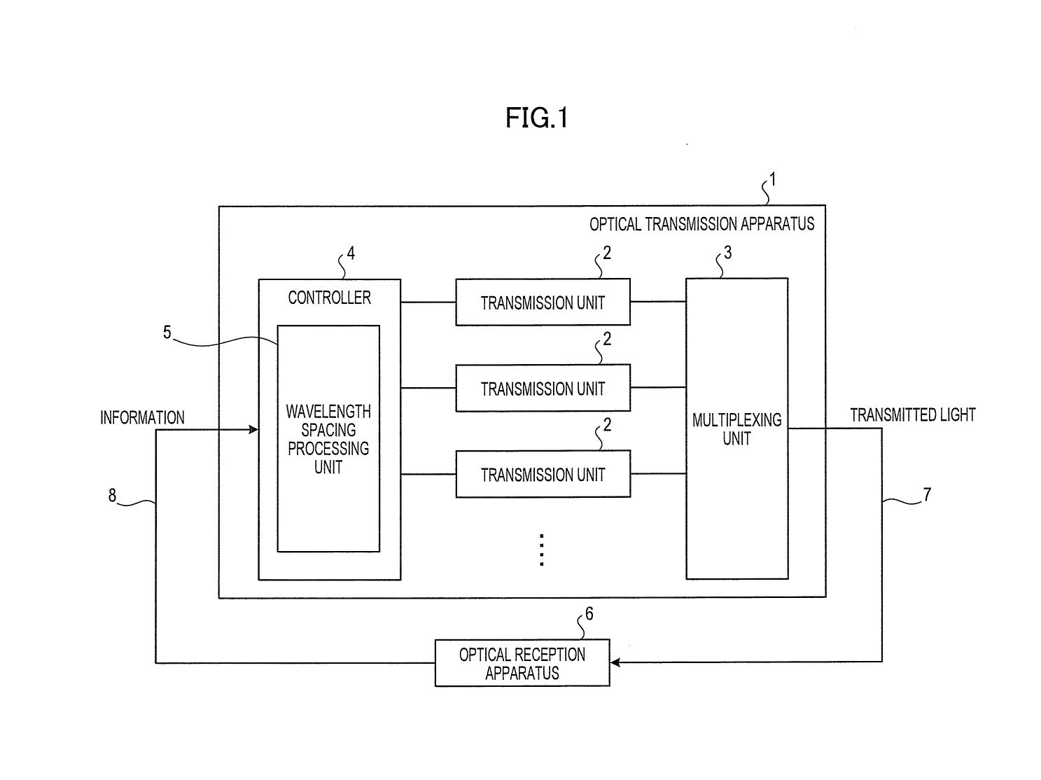

FIG. 1 is a block diagram of a configuration of an optical communication system in an embodiment. As illustrated in FIG. 1, the optical communication system includes an optical transmission apparatus 1. The optical transmission apparatus 1 includes transmission units 2, a multiplexing unit 3, and a controller 4. The transmission units 2 may transmit lights with mutually different wavelengths. The multiplexing unit 3 multiplexes lights transmitted from the transmission units 2. The optical transmission apparatus 1 transmits the light multiplexed by the multiplexing unit 3. The controller 4 controls the transmission units 2 to control the wavelengths of lights that are transmitted from the transmission units 2. The controller 4 may include a wavelength spacing processing unit 5.

When the optical transmission apparatus 1 transmits lights to an optical reception apparatus 6, the wavelength spacing processing unit 5 varies a spacing between mutually adjacent wavelengths of lights that are transmitted from the transmission units 2. And, the wavelength spacing processing unit 5 receives information from the optical reception apparatus 6 that has received light transmitted from the optical transmission apparatus 1. Information that is received by the wavelength spacing processing unit 5 includes information about a reception state in the optical reception apparatus 6, such as information about the transmission quality. The information concerning the transmission quality includes, for example, the Q value serving as an assessment criterion of transmission characteristic. The wavelength spacing processing unit 5 controls a spacing between mutually adjacent wavelengths of lights that are transmitted from the transmission units 2, on the basis of the information received from the optical reception apparatus 6.

The optical reception apparatus 6 detects a reception state of the light transmitted from the optical transmission apparatus 1, and notifies the optical transmission apparatus 1 of information about the reception state. The light having been transmitted from the optical transmission apparatus 1 is transmitted to the optical reception apparatus 6 via an optical transmission path 7. The information that is transmitted from the optical reception apparatus 6 to the optical transmission apparatus 1 either may be transmitted as an optical signal via an optical transmission path 8, or may be transmitted using other wire communication techniques or wireless communication techniques. The optical transmission path 7 may include optical devices such as optical fibers, optical connectors, and optical waveguides.

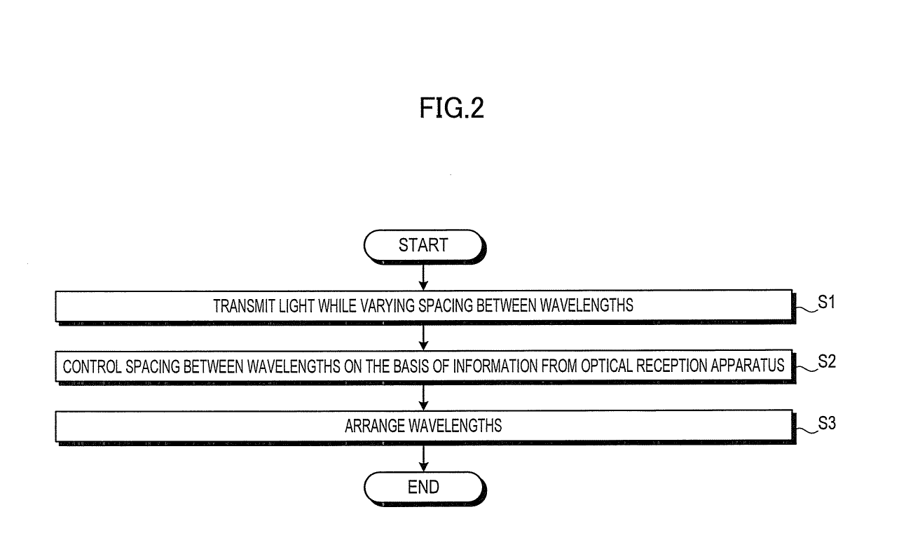

FIG. 2 is a flowchart illustrating a procedure for wavelength arrangement processing in an embodiment. As illustrated in FIG. 2, in the optical transmission apparatus 1, upon start of the wavelength arrangement processing, firstly, the optical transmission apparatus 1, while varying the spacing between mutually adjacent wavelengths by the wavelength spacing processing unit 5, multiplexes lights with mutually different wavelengths, and transmits the multiplexed light to the optical reception apparatus 6 (operation S1). Generally, with a decrease in the spacing between mutually adjacent wavelengths, the reception state such as transmission quality tends to degrade owing to a nonlinear effect (cross-phase modulation or optical four-wave mixing) occurring during transmission. Accordingly, one example method for varying the spacing between mutually adjacent wavelengths is to reduce a spacing between mutually adjacent wavelengths in a gradual manner or a stepwise manner. Another example method for varying the spacing between mutually adjacent wavelengths is to increase the spacing between mutually adjacent wavelengths in a gradual manner or a stepwise manner. The optical reception apparatus 6 receives lights transmitted from the optical transmission apparatus 1 upon separating the light for each wavelength. The optical reception apparatus 6 detects the reception states of the lights, and notifies the optical transmission apparatus 1 of information about the reception states.

Next, the optical transmission apparatus 1 controls the spacing between mutually adjacent wavelengths of lights transmitted from the transmission units 2 by the wavelength spacing processing unit 5, on the basis of the information notified by the optical reception apparatus 6 (operation S2). One example method for controlling by the wavelength spacing processing unit 5 is to cause the spacing between mutually adjacent wavelengths to be a minimum within a range of transmission quality allowable to the system. Then, the optical transmission apparatus 1 arranges wavelengths on the basis of wavelength spacing controlled by the wavelength spacing processing unit 5 (operation S3). One example method for arranging wavelengths is, when the spacing between mutually adjacent wavelengths is controlled to be the minimum spacing by the wavelength spacing processing unit 5, to arrange the wavelengths at the minimum spacing between mutually adjacent wavelengths, or at a spacing equal to an integral multiple of the minimum spacing between mutually adjacent wavelengths.

According to an embodiment, the spacing between mutually adjacent lights that are transmitted from the optical transmission apparatus 1 is controlled by the optical transmission apparatus 1 on the basis of information notified by the optical reception apparatus 6 having received the light transmitted from the optical transmission apparatus 1. Accordingly, in the band having a high transmission quality, wavelengths may be arranged at a narrower wavelength spacing than that recommended by the ITU-T, thereby allowing achievement of an increase in transmission capacity. Furthermore, since the spacing between mutually adjacent wavelengths may be changed in response to a system status, the wavelength spacing may be set in response to the system status.

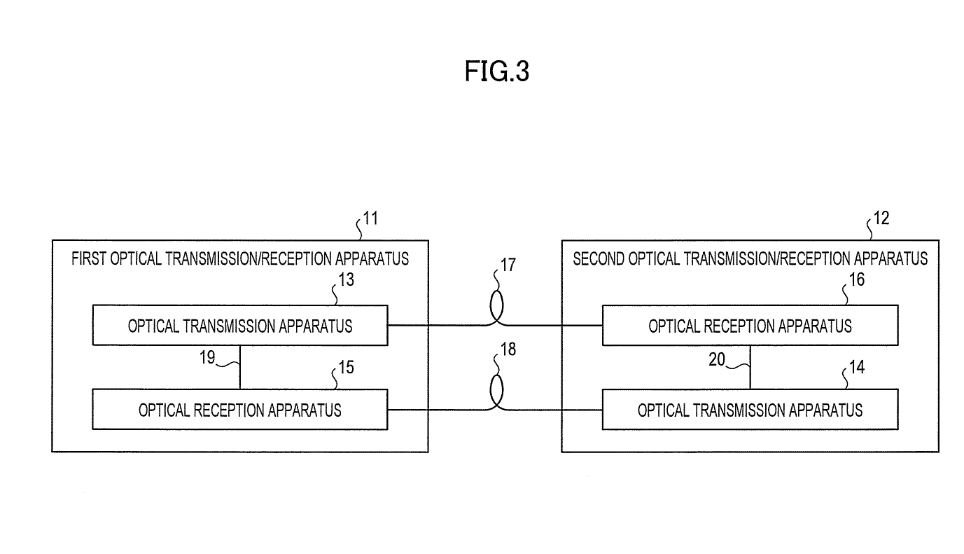

FIG. 3 is a block diagram of the configuration of an optical communication system in an embodiment. The optical communication system includes optical transmission/reception apparatuses, that is, a first optical transmission/reception apparatus 11 and a second optical transmission/reception apparatus 12 in an example of FIG. 3. Each optical transmission/reception apparatuses 11 and 12 includes optical transmission apparatuses 13 and 14 respectively, and optical reception apparatuses 15 and 16 respectively. The optical transmission apparatus 13 in the first optical transmission/reception apparatus 11 is connected to the optical reception apparatus 16 in the optical transmission/reception apparatus 12 via an optical transmission path 17. And, the optical transmission apparatus 14 in the second optical transmission/reception apparatus 12 is connected to the optical reception apparatus 15 in the first optical transmission/reception apparatus 11 via an optical transmission path 18. The optical transmission paths 17 and 18 include optical devices such as optical fibers, optical connecters, optical couplers, and optical waveguides. In the first optical transmission/reception apparatus 11, the optical transmission apparatus 13 and the optical reception apparatus 15 are connected by a signal line 19 such as a bus. And, in the second optical transmission/reception apparatus 12, the optical transmission apparatus 14 and the optical reception apparatus 16 are connected by a signal line 20 such as a bus. The optical transmission paths 17 and 18 may each have an optical amplifier for compensating for loss. Since the first optical transmission/reception apparatus 11 and the second optical transmission/reception apparatus 12 have the same configurations, the first optical transmission/reception apparatus 11 will be explained as a representative example of the optical transmission/reception apparatus.

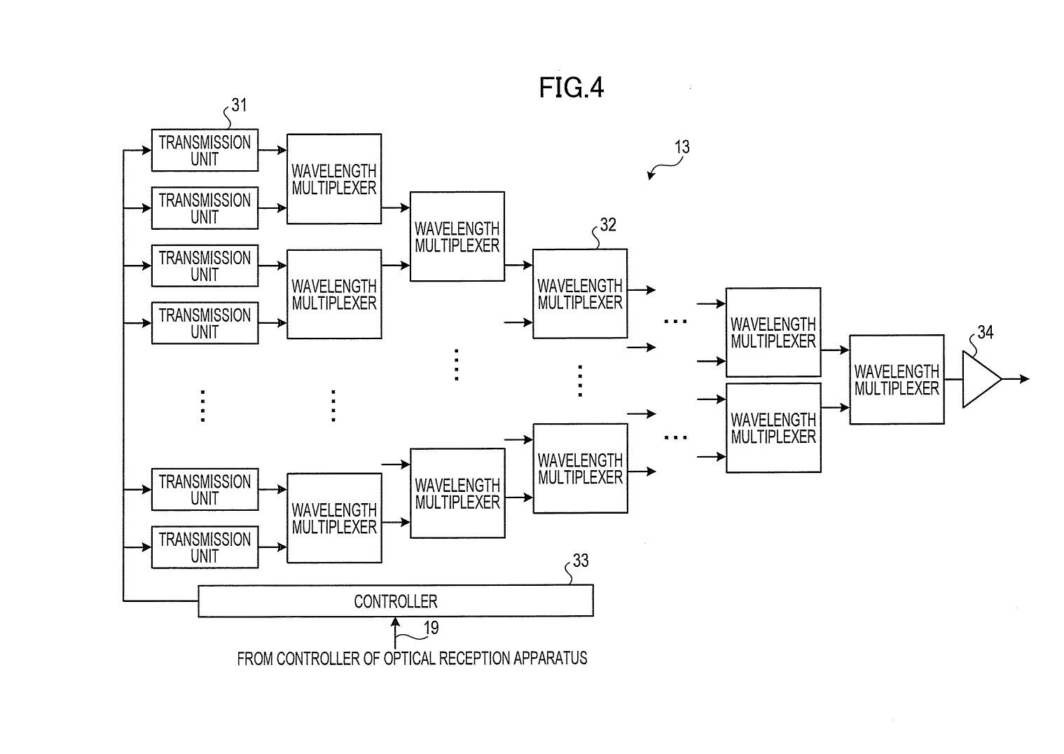

FIG. 4 is a block diagram of a configuration of an optical transmission apparatus in an embodiment. As illustrated in FIG. 4, the optical transmission apparatus 13 includes transmission units 31, wavelength multiplexers 32, a controller 33, and an optical amplifier 34. The transmission units 31 are configured to be able to transmit lights with any wavelength or lights with wavelengths stepwise different from each other. In FIG. 4, as a configuration corresponding to the multiplexing unit 3 in FIG. 1, a multiplexing unit includes, for example, wavelength multiplexers 32 connected in a multistage manner, wavelength-multiplex lights transmitted from transmission units 31 into one light (Wavelength Division Multiplexing (WDM) light) by the multistage wavelength multiplexers 32 and outputs the resulting light. With respect to lights that are transmitted from the transmission units 31, the controller 33 illustrated in FIG. 4 controls the spacing between mutually adjacent wavelengths, a dispersion compensation amount of the dispersion compensator (not illustrated in FIG. 4), and the optical intensity, with respect to lights transmitted from the transmission units 31. The optical amplifier 34 adjusts the transmission power (intensity) of light (WDM light) that is transmitted from the optical transmission apparatus 13.

The wavelength multiplexer 32 may be, for example, an optical coupler without wavelength dependence. One example of a coupler is a coupler that does not multiplex/demultiplex specific wavelengths but that outputs lights from input paths to one output path. In the illustrated example, the wavelength multiplexer 32 multiplexes two input lights into one light and outputs the multiplexed light, but it may multiplexes three inputs or more into one light and outputs it. When a coupler having, for example, two input paths and one output path is used as the wavelength multiplexer 32, loss in the optical coupler is, e.g., about 3 dB. And, in the case where a coupler having, for example, two input paths and one output path is used as the wavelength multiplexer 32, when increasing the number of wavelengths to be multiplexed by the multiplexing part, the configuration of the multiplexing part may be flexibly addressed. That is, when a number of wavelengths that are multiplexed is 2m, a number of wavelength multiplexers 32 is Σ2k (here, k is an integral of 0 to (m−1)). Accordingly, when attempting to increase the number of wavelengths to be multiplexed from 2m to (2m+1), it is only necessary to increase the wavelength multiplexers 32 by 2m. The configuration of the multiplexing unit, therefore, may be flexibly addressed in response to request from the system.

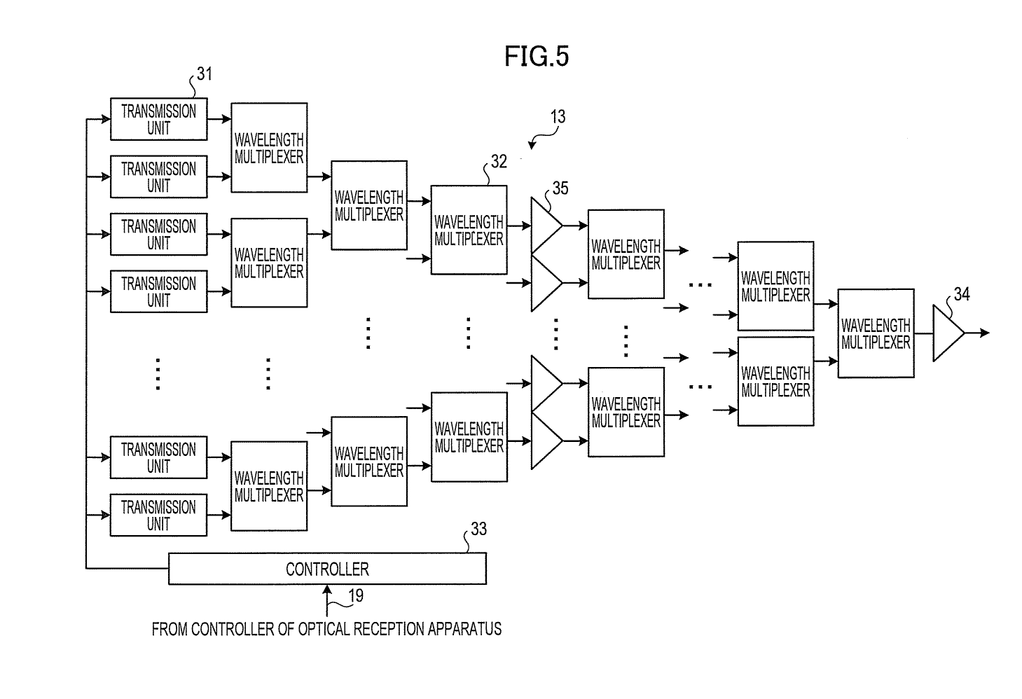

FIG. 5 is a block diagram of another configuration of an optical transmission apparatus in an embodiment. As illustrated in FIG. 5, the optical transmission apparatus 13 may be configured so that an optical amplifier 35 is provided between the pre-stage wavelength multiplexer(s) 32 and the post-stage wavelength multiplexer(s) 32. By doing this, it is possible to compensate for optical attenuation occurring in the wavelength multiplexers 32, so that loss in the multiplexing unit may be suppressed when a number of stages of the wavelength multiplexers 32 is large.

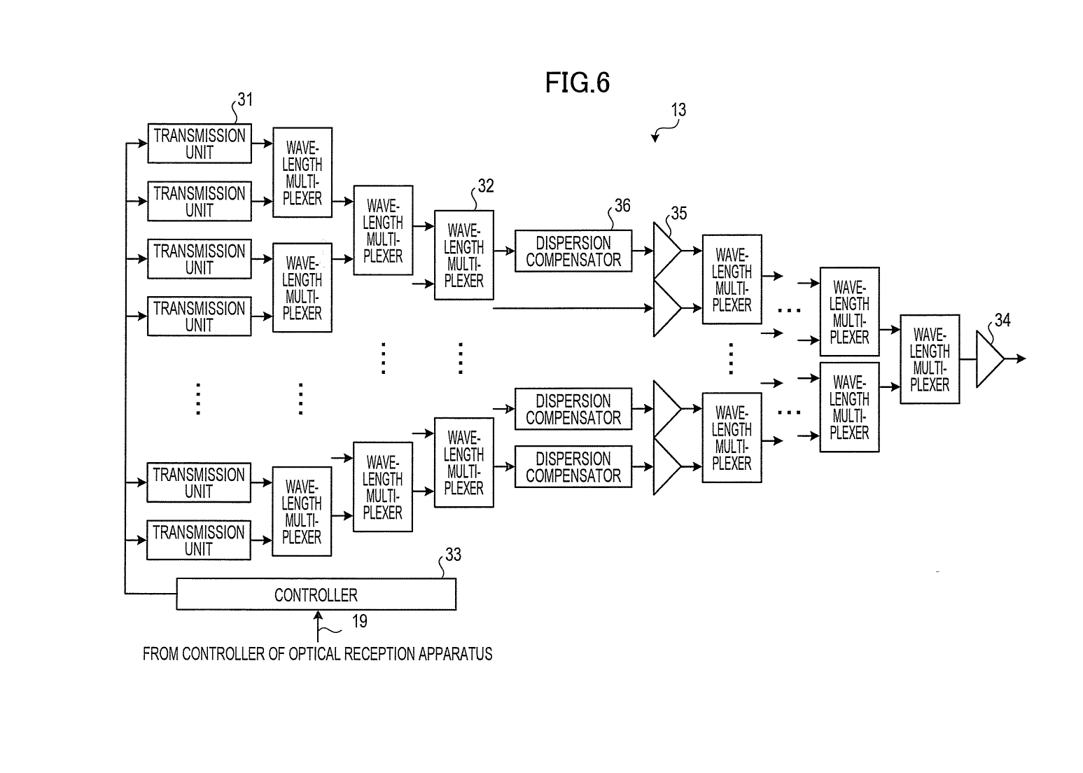

FIG. 6 is a block diagram of still another configuration of an optical transmission apparatus in an embodiment. As illustrated in FIG. 6, the optical transmission apparatus 13 may be configured so that a dispersion compensators 36 without wavelength dependence is provided between the pre-stage wavelength multiplexers 32 and the post-stage wavelength multiplexers 32. By doing this, when the band is wide and the wavelength dispersion amount is large, it is possible to sufficiently compensate for wavelength dispersion by the dispersion compensators 36 between the wavelength multiplexers, along with dispersion compensators, respectively, provided in the transmission units 31 and reception units to be described later. Moreover, along with the dispersion compensators 36, the optical amplifier 35 may be provided between the pre-stage wavelength multiplexers 32 and the post-stage wavelength multiplexers 32 so as to compensate for loss due to the installation of the dispersion compensators 36.

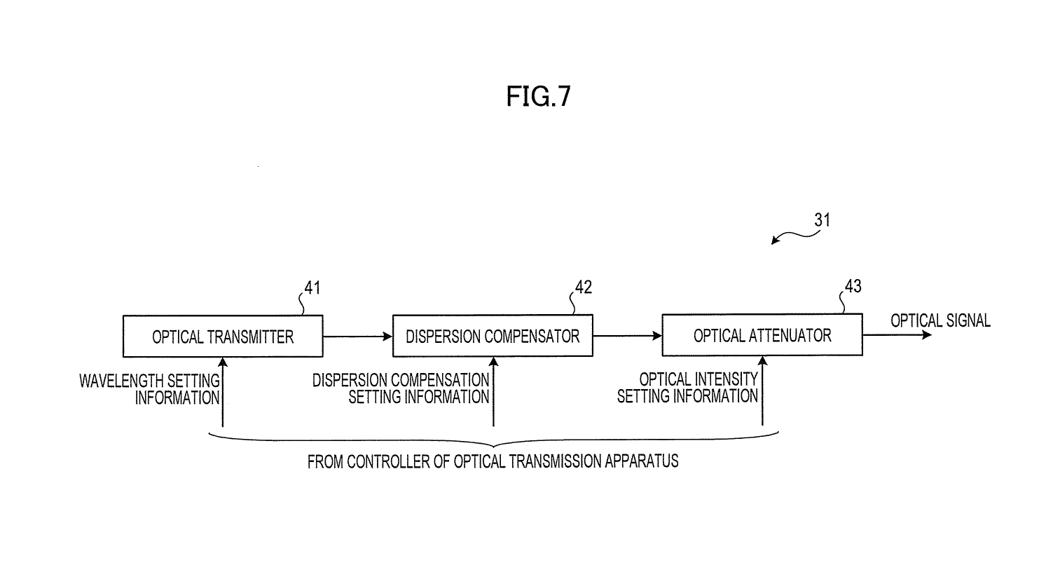

FIG. 7 is a block diagram of a configuration of a transmission unit in an embodiment. As illustrated in FIG. 7, the transmission units 31 each includes an optical transmitter 41, a dispersion compensator 42, and an optical attenuator 43. Each individual optical transmitter 41 is, for example, a tunable laser (wavelength-variable laser) capable of transmitting light with any wavelength, or a tunable laser capable of transmitting lights upon stepwise varying the wavelength at a sufficiently narrower spacing than that recommended by the ITU-T. One example of a sufficiently narrower wavelength spacing (frequency spacing) than that recommended by the ITU-T is a spacing on the level of several GHz. The wavelength of light transmitted by the optical transmitter 41 is set by wavelength setting information provided by the controller 33 in the optical transmission apparatus 13. Meanwhile, the optical transmitter 41 is not limited to a tunable laser, as long as it can transmit light with any wavelength, or light stepwise different in wavelength from each other at a sufficiently narrower spacing than, for example, that recommended by the ITU-T.

The dispersion compensator 42, without wavelength dependence, is a variable dispersion compensator capable of varying dispersion compensation amount over a wide bandwidth with respect to both the positive dispersion and negative dispersion. The variable dispersion compensator may compensate for wavelength dispersion amount by any compensation amount regarding any wavelength. Examples of dispersion compensator 42 include, a dispersion compensation optical fiber serving as a fiber-type apparatus, a dispersion compensator employing etalon, and other dispersion compensators. The dispersion compensation amount of the dispersion compensator 42 is set by dispersion compensation setting information provided by the controller 33 in the optical transmission apparatus 13.

The optical attenuator 43 is a variable optical attenuator and, for example, adjusts the transmitted light intensity (power) level. One example of transmitted light intensity level is a set value (hereinafter referred to as a PE value) when pre-emphasis is performed. Examples of optical attenuator include a variable optical attenuator equipped with a Mach-Zehender phase modulation circuit and other variable optical attenuators. The optical attenuation amount of the optical attenuator 43, that is, the transmitted light intensity level is set by optical intensity setting information provided by the controller 33 in the optical transmission apparatus 13.

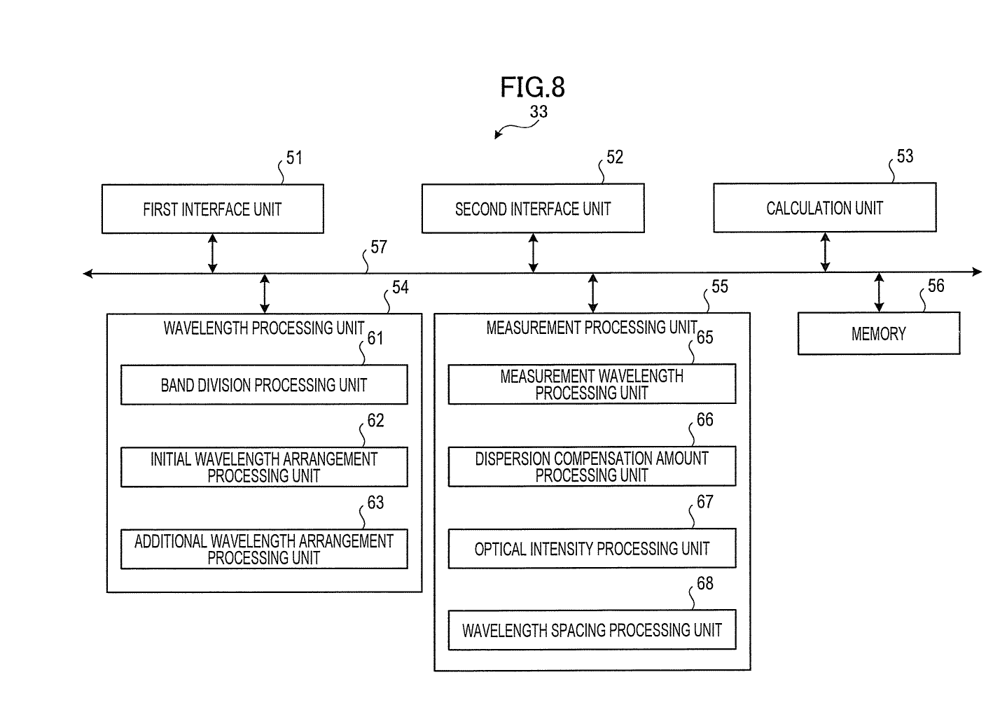

FIG. 8 is a block diagram of a configuration of a controller in an embodiment. As illustrated in FIG. 8, the controller 33 includes a first interface unit 51, a second interface unit 52, a calculation unit 53, a wavelength processing unit 54, a measurement processing unit 55, and a memory 56. These units are connected with respect to one another via a bus 57. The wavelength processing unit 54 includes a band division processing unit 61, an initial wavelength arrangement processing unit 62, and an additional wavelength arrangement processing unit 63. The measurement processing unit 55 includes a measurement wavelength processing unit 65, a dispersion compensation amount processing unit 66, an optical intensity processing unit 67, and a wavelength spacing processing unit 68.

The first interface unit 51 performs control for transmitting/receiving wavelength setting information, dispersion compensation setting information, or optical intensity setting information to/from the transmission units 31. The second interface unit 52 performs control for transmitting/receiving information concerning a controller (described later) in the optical reception apparatus 15. The calculation unit 53 controls the entire optical transmission apparatus 13. The memory 56 stores various setting information such as wavelength setting information, dispersion compensation setting information and optical intensity (power) setting information, and data obtained by measurements by various processing units in the measurement processing unit 55. The memory 56 may be a nonvolatile memory. Examples of nonvolatile memories include semiconductor memories such as electrically erasable programmable read only memory (EEPROM) and ferroelectric random access memory (FeRAM).

The band division processing unit 61 divides an entire wavelength band (frequency band) of the system into blocks. For each of the divided blocks, the wavelength dependence of transmission quality is measured by the measurement processing unit 55 as a characteristic of band. At measurement, the increase of the number of blocks narrows a bandwidth per block to thereby allows measuring characteristic in the block with more accuracy.

On the other hand, the decrease of the number of blocks allows shortening time needed for measurement. Furthermore, since the amount of data obtained by the measurement decreases, accumulated data amount may be reduced.

In general, when the entire wavelength band is divided into three blocks: a block near the center, a block on a shorter wavelength side than the central block, and a block on a longer wavelength side than the central block, the three blocks represent mutually different characteristics. It is therefore possible to divide the entire wavelength band into at least the three blocks: the block near the center, the block on the shorter wavelength side than the central block, and the block on the longer wavelength side than the central block. Instead, the number of blocks may be four or more.

At the start of operation of the system, the initial wavelength arrangement processing unit 62 determines the arrangement of wavelengths on the basis of spacing determined by the wavelength spacing processing unit 68. The additional wavelength arrangement processing unit 63, when wavelengths are newly added during the operation of the system, determines the arrangement of wavelengths to be added on the basis of the wavelength spacing determined by the wavelength spacing processing unit 68.

The measurement wavelength processing unit 65 sets wavelengths when the measurement of transmission quality is performed, and outputs wavelength setting information to the optical transmitter 41. The number of wavelengths to be set by the measurement wavelength processing unit 65 may be three or more. By setting three or more wavelengths, it is possible to measure, by the wavelength spacing processing unit 68, the degree of the degradation of transmission quality at the time when wavelengths λb and λc that are mutually adjacent on the shorter wavelength side and longer wavelength side, respectively, relative to certain wavelength λa are brought closer to the λa. The spacing between wavelengths (spacing between frequencies) set by the measurement wavelength processing unit 65, for example, is 200 GHz, 100 GHz, 50 GHz, or 25 GHz recommended by the ITU-T.

When performing initial setting of wavelengths and/or dispersion compensation amount of the system, since the wavelength used for transmission may not be specified, it is possible to gradually narrow the spacing between wavelengths with the wavelength arrangement according to the frequency grid recommended by the ITU-T as a reference (initial value). Information about the wavelengths set by the measurement wavelength processing unit 65 may be transmitted to an optical reception apparatus of a communication partner, utilizing an overhead of the transmitting signal frame, for example.

The dispersion compensation amount processing unit 66 outputs dispersion compensation setting information to the dispersion compensator 42, and controls the amount of dispersion compensation by the dispersion compensator 42. The dispersion compensation amount processing unit 66, when measuring the transmission quality, for example, while varying the dispersion compensation amount of light that is transmitted from the transmission units 31, measures information about transmission quality returned from the optical transmission/reception apparatus of the communication partner. The dispersion compensation amount processing unit 66 controls the dispersion compensation amount of light that are transmitted from the transmission units 31, on the basis of measured results of the information about transmission quality, for example, of each optical signal.

The optical intensity processing unit 67 outputs optical intensity setting information to the optical attenuator 43 and, for example, adjusts the intensity level obtained by the optical attenuator 43. The optical intensity processing unit 67, when measuring the transmission quality, for example, while varying the transmitted light intensity level of the light the is transmitted from the transmission units 31, measures information about transmission quality returned from the optical transmission/reception apparatus of the communication partner. The optical intensity processing unit 67 controls the transmitted light intensity level of the light that is transmitted from the transmission units 31, on the basis of measured results of the information about transmission quality.

The wavelength spacing processing unit 68, when measuring the transmission quality, outputs wavelength setting information to the optical transmitter 41, and while varying the spacing between mutually adjacent wavelengths of lights that are transmitted from the transmission units 31, measures information about transmission quality returned from the optical transmission/reception apparatus of the communication partner. The wavelength spacing processing unit 68 determines, for example, a minimum spacing between mutually adjacent wavelengths of the lights that are transmitted from the transmission units 31, on the basis of measured results of the information about the transmission quality. Some processing units or all processing units of the band division processing unit 61, the initial wavelength arrangement processing unit 62, additional wavelength arrangement processing unit 63, the measurement wavelength processing unit 65, the dispersion compensation amount processing unit 66, the optical intensity processing unit 67, and the wavelength spacing processing unit 68 may either be constituted by hardware, or may either have configurations implemented, for example, by the calculation unit 53 executing software stored in the memory 56.

The optical transmission apparatus 13 in FIG. 3, if the first optical transmission/reception apparatus 11 including the optical transmission apparatus 13 itself is a apparatus of which the wavelength dependence of transmission quality is to be measured, i.e., a apparatus playing a role as the optical reception apparatus 6 in FIG. 1, then, has the following function. The optical transmission apparatus 13 transmits one piece, or two or more pieces of information of the wavelength setting information, the dispersion compensation setting information, and the optical intensity setting information to an optical transmission/reception apparatus of a communication partner utilizing an overhead for example. And, the optical transmission apparatus 13, if an optical transmission/reception apparatus of the communication partner is an apparatus of which the wavelength dependence of transmission quality is to be measured, i.e., an apparatus playing a role as the optical reception apparatus 6 in FIG. 1, then, has the following function. The optical transmission apparatus 13 transmits information about the transmission quality of light transmitted from the optical transmission/reception apparatus of the communication partner to the optical transmission/reception apparatus of the communication partner utilizing an overhead for example.

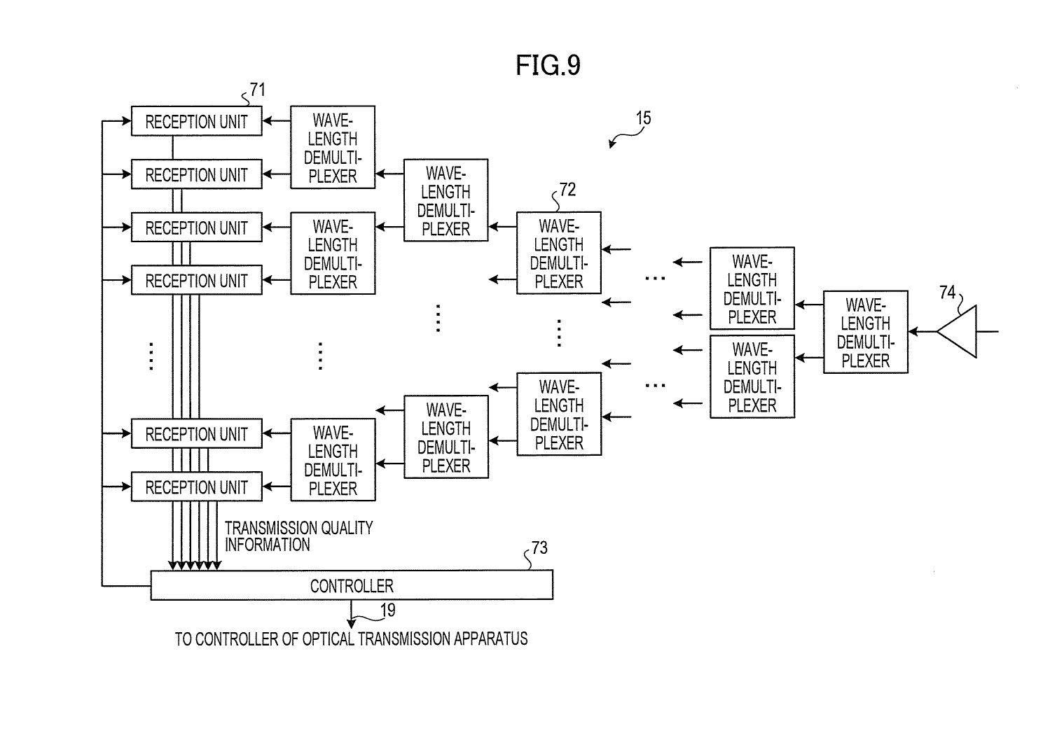

FIG. 9 is a block diagram of a configuration of an optical reception apparatus in an embodiment. As illustrated in FIG. 9, the optical reception apparatus 15 includes reception units 71, wavelength demultiplexers 72, a controller 73, and an optical amplifier 74. The optical amplifier 74 amplifies light attenuated on the optical path. The wavelength demultiplexers 72 are connected, for example, in a multistage manner, and separate the light amplified by the optical amplifier 74 for each wavelength. The wavelength demultiplexers 72 each includes, for example, an optical coupler without wavelength dependence. One example of an optical coupler used here is the same coupler as that used for the wavelength multiplexer 32 in the optical transmission apparatus 13. In the example illustrated in FIG. 9, the wavelength demultiplexers 72 each demultiplexes one input light into two lights and outputs them, but they may demultiplex one input light into three or more lights and outputs them. As in the case of the multiplexer in the optical transmission apparatus 13, the optical reception apparatus may be configured so that one or both of the optical amplifier and the dispersion compensator without wavelength dependence are provided between the pre-stage wavelength demultiplexer(s) 72 and the post-stage wavelength demultiplexer(s) 72.

The reception units 71 receive respective lights separated for each wavelength by the wavelength demultiplexers 72. The controller 73 controls the reception units 71. The controller 73 includes an interface unit that controls transmission/reception to/from the reception units 71 and the controller 33 in the optical transmission apparatus 13, and a calculating unit controlling the entire optical reception apparatus 15, and a memory. These interface unit, calculating unit, and memory are connected with respect to one another via a bus.

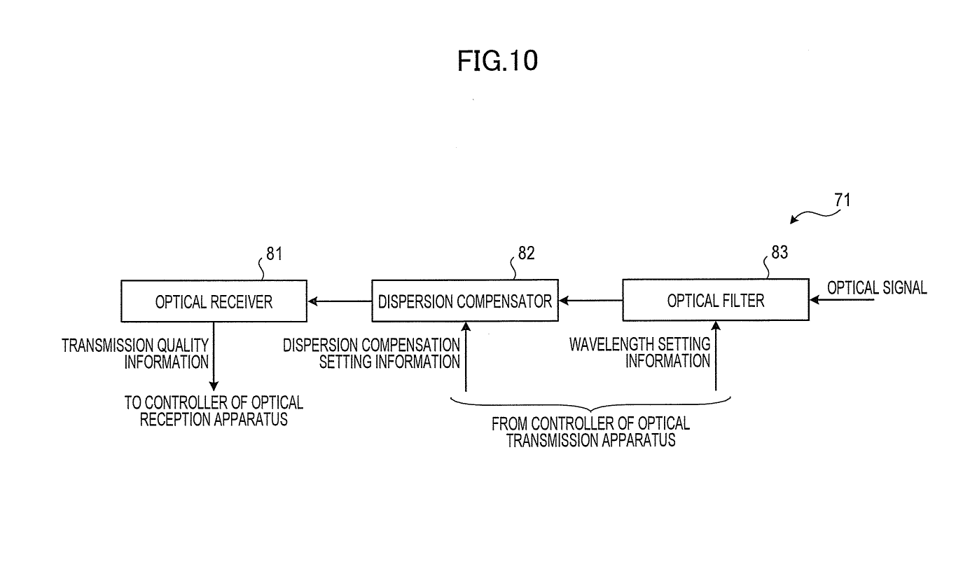

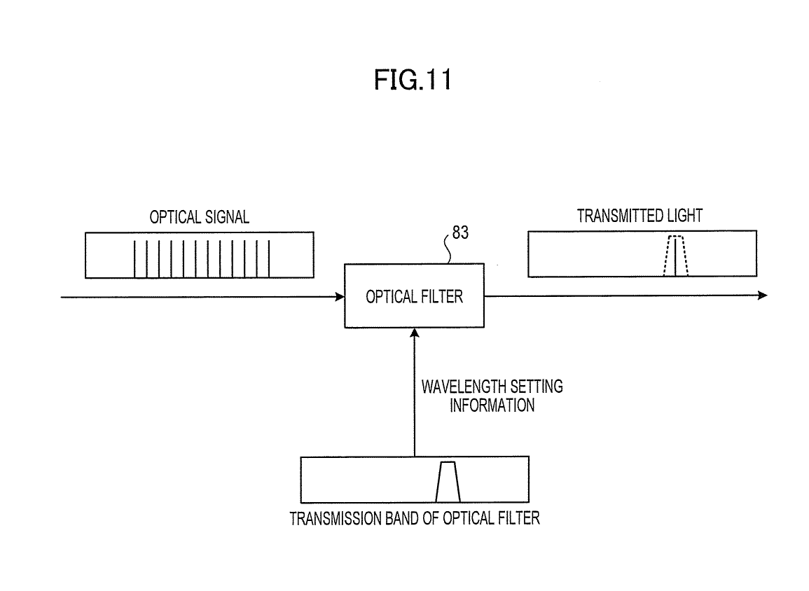

FIG. 10 is a block diagram of a configuration of a reception unit in an embodiment. FIG. 11 is an explanatory diagram of characteristics of an optical filter in an embodiment. As illustrated in FIG. 10, the reception unit 71 includes an optical receiver 81, a dispersion compensator 82, and an optical filter 83. As illustrated in FIG. 11, the optical filter 83 removes accumulated noise light and wavelengths other than a desired wavelength, and transmits a specified narrow wavelength band alone. The optical filter 83 is, for example, a variable optical filter, and may set any wavelength transmission band out of a wide wavelength band, on the basis of the wavelength setting information provided by the controller 73. The wavelength setting information is sent from the optical transmission/reception apparatus of a communication partner. In FIG. 10, it is possible that the dispersion compensator 82 be a variable dispersion compensator without wavelength dependence, and that capable of varying dispersion compensation amount over a wide band with respect to both the positive dispersion and negative dispersion. One example of the dispersion compensator 82 is the same one as that the dispersion compensator 42 in the optical transmission apparatus 13. The compensation amount of the dispersion compensator 82 is set by the dispersion compensation setting information provided by the controller 73.

The optical receiver 81 in FIG. 10 receives light output from the dispersion compensator 82. The optical receiver 81, if the optical transmission/reception apparatus of a communication partner is an apparatus of which the wavelength dependence of transmission quality is to be measured, then, receives light with a measured wavelength transmitted from the optical transmission/reception apparatus of a communication partner. Then, the optical receiver 81 measures transmission quality of the received optical signal, and notifies the controller 73 of information about the transmission quality. The information about the transmission quality is sent from the controller 73 to the controller 33 in the optical transmission apparatus 13, and for example, utilizing an overhead of the transmitting frame, the information is transmitted from the optical transmission apparatus 13 to the optical transmission/reception apparatus of the communication partner. The optical receiver 81, if the optical transmission/reception apparatus including the optical receiver 81 itself is an apparatus of which the wavelength dependence of transmission quality is to be measured, then, receives the information about the transmission quality sent from the optical transmission/reception apparatus of the communication partner utilizing an overhead for example. Then, the optical receiver 81 sends the information about the transmission quality to the controller 33 in the optical transmission apparatus 13 via the controller 73. On the basis of the information about the transmission quality sent from the optical reception apparatus 15, the optical transmission apparatus 13, as described above, controls the dispersion compensation amount and the transmitted light intensity (power) level of the light transmitted from the transmission unit 31, and determines, for example, a minimum spacing between mutually adjacent wavelengths.

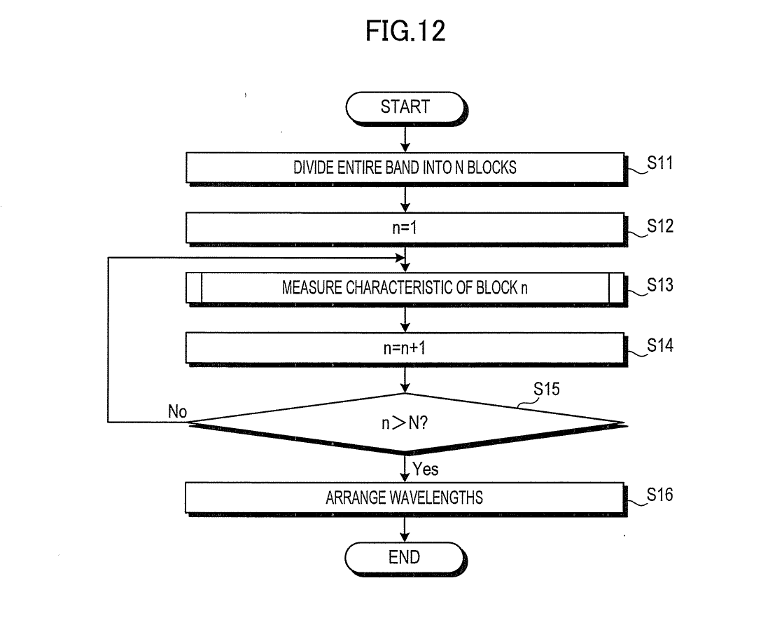

FIG. 12 is a flowchart illustrating a procedure for wavelength arrangement processing in an embodiment. Here, description is made of a case where, in the optical communication system illustrated in FIG. 3, the optical communication system, wavelengths of lights that are transmitted from the first optical transmission/reception apparatus 11 are arranged. As illustrated in FIG. 12, upon start of the arrangement processing of wavelengths in the first optical transmission/reception apparatus 11, firstly, the band division processing unit 61 in the transmission unit 31 divides the entire wavelength band into N blocks (operation S11). Here, N is an integral equal to or more than 2, and is preset. As described above, since the entire band may be divided into at least three blocks, N is desirably 3 or more. Here, N is assumed to be an integral equal to or more than 3.

Next, the value of a variable n is set to 1 (operation S12). Then, for the convenience' sake, the N blocks are numbered starting from 1, and a first block (block 1) is measured (operation S13). Processing for measuring characteristics of blocks is described later. Upon completion of the measurement of the block 1 in operation S13, the spacing between wavelengths in the block 1 is determined. Next, the n value is incremented to 2 (operation S14). Then, the values of n and N are compared. Since the n value is 2 and the N value is an integral equal to or more than 3, the n value is not larger than the N value (operation S15: No). Accordingly, the process returns to operation S13, and the characteristic of a second block (block 2) is measured. As a result, the minimum spacing between wavelengths in the bock 2 is determined in operation S13. By repeating operation S13 to operation S15, characteristics of all blocks are measured, whereby the minimum spacing between wavelengths in each of the bocks is determined. If the n value becomes larger than the N value in operation S15 (operation S15: Yes), the initial wavelength arrangement processing unit 62 in the optical transmission apparatus 13 arranges wavelengths at the start of operation of the system, on the basis of the minimum spacing between wavelengths in each of the blocks determined in operation S13, (operation S16).

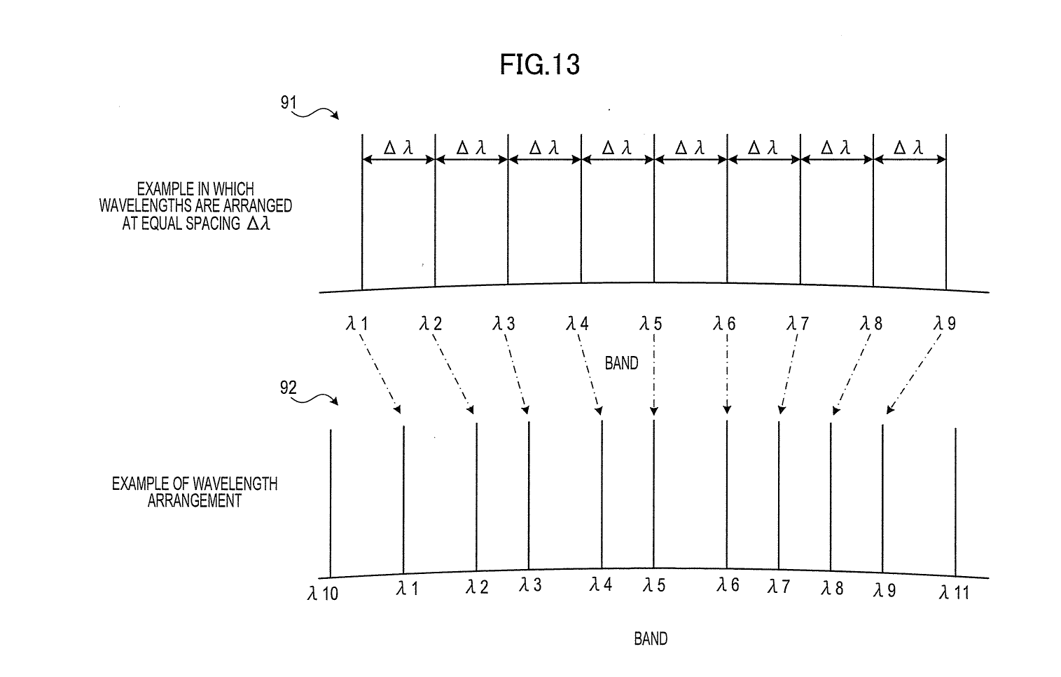

FIGS. 13, 14 and 15 are explanatory diagrams illustrating examples of wavelength arrangements in an embodiment. As illustrated in FIG. 13, in an arrangement example 91 in which wavelengths are arranged at an equal spacing Δλ, regarding bandwidth Bw, [(Bw/Δλ)+1] wavelengths are arranged. When the wavelength spacings Δλ are equal to one another, in the arrangement example 91 illustrated in FIG. 13, for example, 9 wavelengths: λ1 to λ9 are arranged. In contrast, in an arrangement example 92 in which wavelengths are arranged in accordance with the wavelength arrangement processing illustrated in FIG. 12, in some blocks, a minimum spacing between wavelengths is smaller than Δλ, so that, for example, 11 wavelengths: λ1 to λ11 are arranged. The here illustrated number of wavelengths is illustrative only.

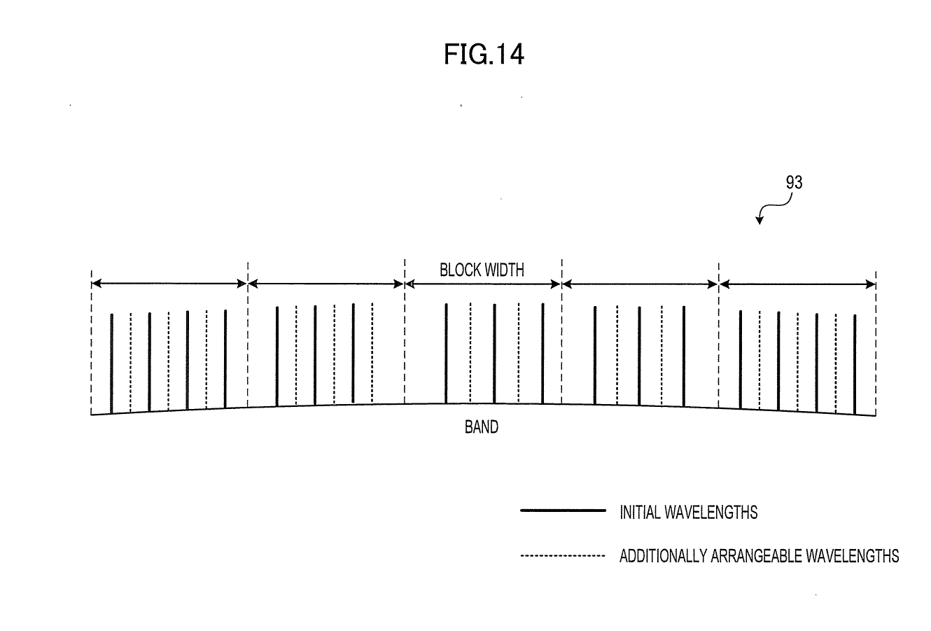

Following is an example method for arranging wavelengths at a start of operation of the system. For example, the initial wavelength arrangement processing unit 62 may arrange wavelengths to be arranged at the start of operation of the system as uniformly as possible over the entire band of the system. For example, in each block, wavelengths may be arranged at a spacing m times wider than the minimum spacing between wavelengths in the block. Here, no is an integral equal to or more than 2. For example, as in the arrangement example 93 illustrate in FIG. 14, within each block width indicated by an arrow, wavelength may be arranged at a spacing twice wider than the minimum spacing between wavelengths in the block. Arranging wavelengths in this way allows the prevention of reduction in the optical signal-to-noise ratio (OSNR) occurring by noise light being amplified in band portions where no wavelength is arranged.

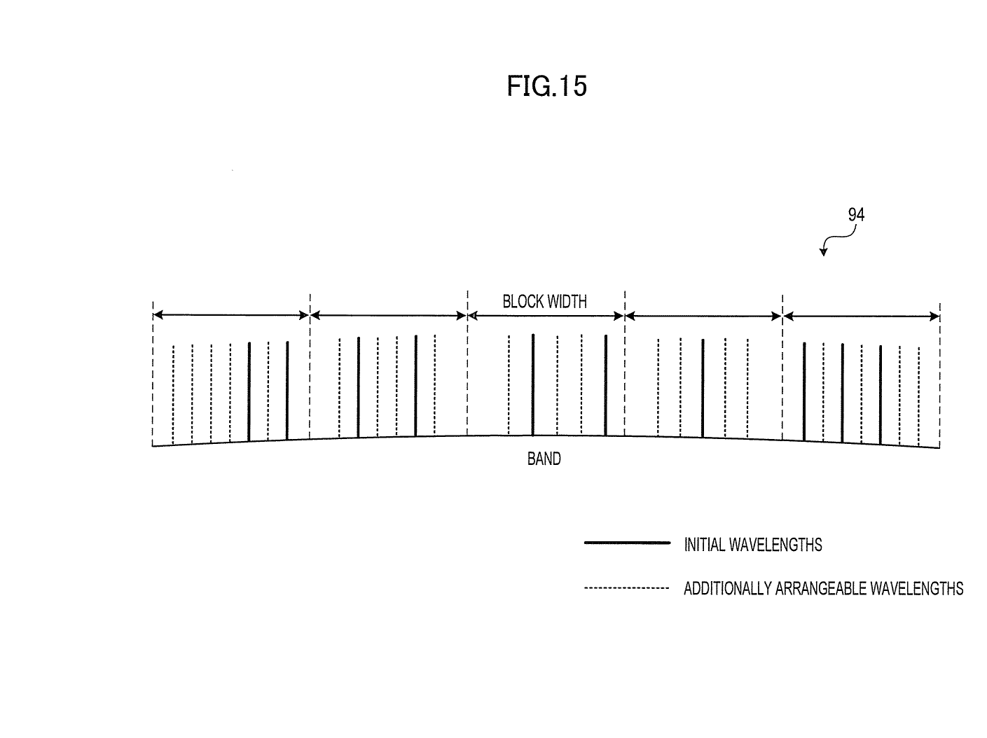

Alternatively, as in the arrangement example 94 illustrated in FIG. 15, when many wavelengths are already arranged at the start of operation of the system, the initial wavelength arrangement processing unit 62 may densely arranges wavelengths in band portions high in accumulated wavelength dispersion amount after transmission, while it may coarsely arrange wavelengths in band portions low in wavelength dispersion during the transmission. For example, the value of the m value may be arranged to be higher in the band portions low in wavelength dispersion during the transmission than in the band portions high in accumulated wavelength dispersion amount after the transmission. In the band portions low in wavelength dispersion, narrowing the spacing between wavelengths enhances the degree of degradation of transmission quality, e.g., Q value under effect of cross-phase modulation, but by performing such a wavelength arrangement, characteristic may be ensured more easily. Meanwhile, in FIG. 14 and FIG. 15, wavelengths arranged at the start of operation of the system is referred to as “initial wavelengths”, and wavelengths newly added during the operation of the system is referred to as “additionally arrangeable wavelengths”.

Following is an example method for newly arranging wavelengths during the system operation. The additional wavelength arrangement processing unit 63, firstly, in each block, may arrange wavelengths at the spacing m times wider than the minimum spacing between wavelengths in the block. At that time, once some block has been filled with wavelengths at the spacing m times wider than the minimum spacing between wavelengths in the block, the additional wavelength arrangement processing unit 63 may successively arrange wavelengths in the same way with respect to other blocks. Once all blocks has been filled with wavelengths at the spacing m times wider than the minimum spacing between wavelengths in the block, the additional wavelength arrangement processing unit 63 may sequentially arrange new wavelengths between the wavelengths that have been already arranged, for example, from around the center of entire band toward the shorter wavelength side or the longer wavelength side in the entire band so as to satisfy the minimum spacing between wavelengths in the block. When all blocks are filled with wavelengths arranged at the minimum spacing between wavelengths in the block, the transmission capacity of the optical communication system becomes a maximum.

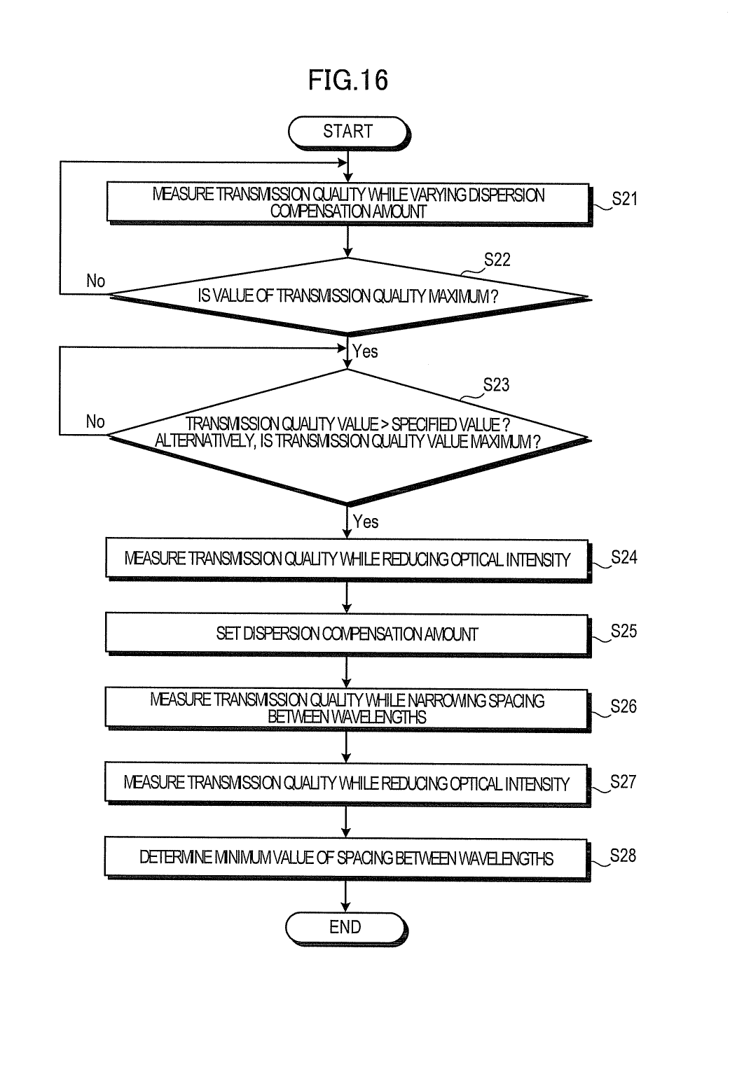

FIG. 16 is a flowchart illustrating a measurement processing procedure for characteristics in an embodiment. Here, as an example, information about transmission quality and transmitted light intensity level are assumed as a Q value and a PE value respectively. When, out of the blocks divided in operation S11, a block to be measured is started to be measured, firstly, in the first optical transmission/reception apparatus 11, the measurement wavelength processing unit 65 in the optical transmission apparatus 13 sets wavelengths at a specified spacing in a band of the block to be measured is started to be measured. Here, three wavelengths are set at a spacing of 100 GHz for example. The optical transmission apparatus 13 multiplexes lights with the three wavelengths and transmits the multiplexed light to the second optical transmission/reception apparatus 12 of a communication partner. At that time, the first optical transmission/reception apparatus 11 transmits the wavelength setting information to the second optical transmission/reception apparatus 12 utilizing an overhead of transmitted optical signals. The second optical transmission/reception apparatus 12 on the reception side reads the wavelength setting information from the overhead, and receives the light transmitted from the first optical transmission/reception apparatus 11 upon adjusting the optical filter 83 of the optical reception apparatus 16.

However, when performing transmission from the first optical transmission/reception apparatus 11 to the second optical transmission/reception apparatus 12 for the first time, a wavelength set by the measurement wavelength processing unit 65 in the first optical transmission/reception apparatus 11 may not coincide with a transmission band of the optical filter 83 in the second optical transmission/reception apparatus 12. In this case, the second optical transmission/reception apparatus 12 may not read information of the overhead. In such a case, therefore, the second optical transmission/reception apparatus 12 may extensively vary the transmission band of the optical filter 83 so as to conform the transmission band of the optical filter 83 to a band that indicates a maximum reception power.

When the second optical transmission/reception apparatus 12 becomes ready for reception, as illustrated in FIG. 16, the first optical transmission/reception apparatus 11, while controlling the dispersion compensator 42 in the transmission units 31 by the dispersion compensation amount processing unit 66 in the optical transmission apparatus 13 to vary the dispersion compensation amount, performs a transmission form the first optical transmission/reception apparatus 11 to the second optical transmission/reception apparatus 12. At that time, in the second optical transmission/reception apparatus 12, the dispersion compensation amount of the dispersion compensator 82 in the reception units 71 may be arranged to be adjusted. That is, the dispersion compensation amount may be changed in both of the dispersion compensator 42 on the transmission side and the dispersion compensator 82 on the reception side. For example, regarding the dispersion compensator 42 on the transmission side, the dispersion compensation amount may be stepwise varied from its lower limit, while regarding the dispersion compensator 82 on the reception side, the dispersion compensation amount may be extensively varied with respect to each stage of the dispersion compensation amount on the transmission side. The second optical transmission/reception apparatus 12 returns, to the first optical transmission/reception apparatus 11, a Q value as the information on transmission quality during the reception. The first optical transmission/reception apparatus 11 measures the Q value returned from the second optical transmission/reception apparatus 12, and accumulates, in the memory 56, data indicating the relationship between Q values and dispersion compensation amounts (operation S21).

The first optical transmission/reception apparatus 11 measures Q values while varying the dispersion compensation amount, until the Q value attains a maximum value, and accumulates the data indicating the relationship between Q values and dispersion compensation amounts (operation S22: No; and operation S22).

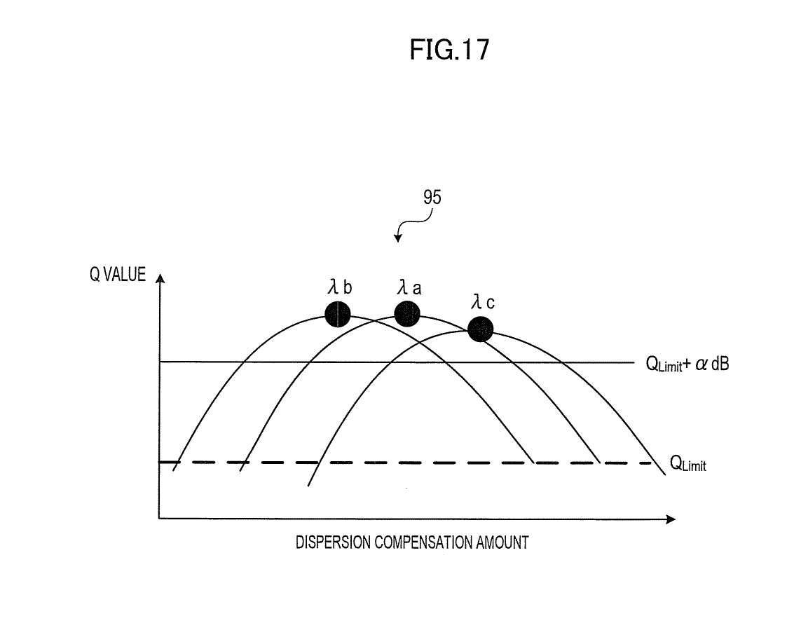

FIG. 17 illustrates an example of a relationship between Q values and dispersion compensation values. In a graph 95 illustrated in FIG. 17, λa, λb, and λc represent three wavelengths measured immediately after the start of measurement processing, and have a relationship: λb<λa<λc for example. Here, Q_{Limit} denotes a lower limit of the Q value allowable for the system, and a denotes a margin for the lower limit of the Q value (the same applies to other figures). One example of margin α is 2 dB. And, the dispersion compensation amount may be manually adjusted upon estimating it from transmission distance, dispersion amount, dispersion slope, or the like. By adjusting, in advance, the dispersion compensation amount in steps S21 and S22, the bit error rate (BER) may be reduced. Moreover, by accumulating, in advance, data indicating the relationships between Q values and dispersion compensation amounts, the dispersion compensation amount may be optimally set.

When the Q value has attained a maximum value (operation S22: Yes), the first optical transmission/reception apparatus 11 fixes the dispersion compensation amount, and sets PE values (optical intensity (power) levels) of the three wavelength set by the measurement wavelength processing unit 65 to nearly the same value by the optical intensity processing unit 67 in the optical transmission apparatus 13. Then, the first optical transmission/reception apparatus 11 measures the Q value returned from the second optical transmission/reception apparatus 12 regarding each wavelength, and accumulates, in the memory 56, data indicating the relationship between Q values and PE values. If the Q value at this time is larger than a specified value (operation S23: Yes), the optical intensity processing unit 67 measures a shift in the Q value while stepwise reducing the PE value, and accumulates, in the memory 56, data indicating the relationship between Q values and PE values (operation S24). One example of the specified value is Q_{Limit} added to by a margin. For example, the margin is 3 dB.

In operation S23, if the Q value is lower than the Q_{Limit} value (operation S23: No), the optical intensity processing unit 67 increases the PE value. If the Q value becomes a higher value than the Q_{Limit} by a specified value, e.g., about 3 dB (operation S23: Yes), the optical intensity processing unit 67 measures a shift in the Q value while stepwise reducing the PE value, and accumulates, in the memory 56, data indicating the relationship between Q values and PE values (operation S24). In operation S23, if the Q value does not become a higher value than the Q_{Limit} value by a specified value, e.g., about 3 dB (operation S23: No), the optical intensity processing unit 67 increases the PE value until the Q value attains the maximum value. If the Q value attains the maximum value (operation S23: Yes), the optical intensity processing unit 67 measures a shift in the Q value while stepwise reducing the PE value, and accumulates, in the memory 56, data indicating the relationship between Q values and PE values (operation S24). In operation S24, the relationship between Q values and PE values is repetitively measured until the Q value attains the Q_{Limit}.

Generally, increasing the PE value improves the OSNR after transmission, and enhances the Q value.

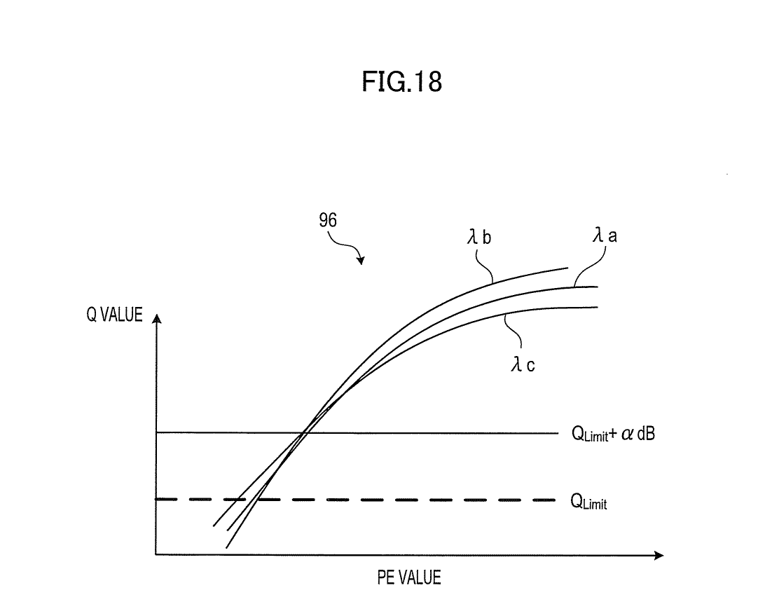

FIG. 18 illustrates an example of a relationship between Q values and PE values. As in a graph 96 illustrated in FIG. 18, when power of light during transmission becomes high to some extent, an increase of Q value stops owing to a nonlinear effect such as self-phase modulation occurring in the transmission path, and a more increase of the PE value reduces the Q value.

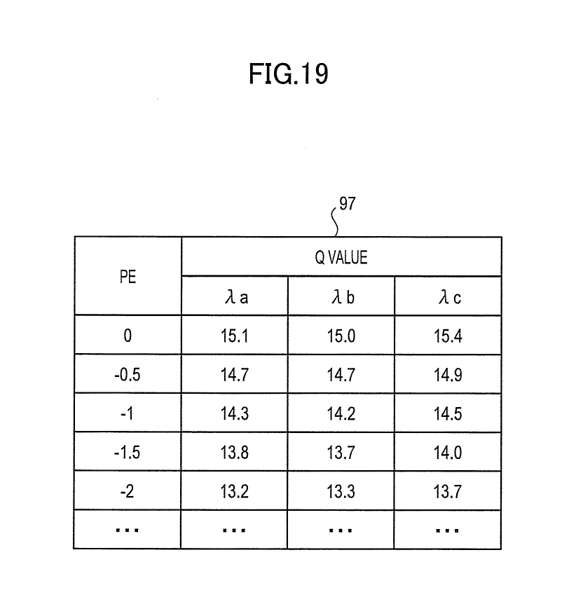

FIG. 19 illustrates an example of measurement data 97 on the relationship between Q values and PE values. By accumulating, in advance, data indicating the relationship between Q values and PE values, the PE value may be optimally set.

Next, the first optical transmission/reception apparatus 11 sets a PE value by the optical intensity processing unit 67 so that the Q value take a value higher than the Q_{Limit} by a specified value, e.g., about 2 dB. Then, first optical transmission/reception apparatus 11 again adjusts the dispersion compensator to set the dispersion compensation amount to an optimal value by the dispersion compensation amount processing unit 66 (operation S25). Then, the first optical transmission/reception apparatus 11 fixes the dispersion compensation amount to the optimum value, and narrows the spacing between the three wavelengths set for measurement, by the wavelength spacing processing unit 68. For example, the wavelength spacing processing unit 68 brings the above-described λb and λc close to λa. Then, the wavelength spacing processing unit 68 measures a shift in the Q value while narrowing the spacing between wavelengths, and accumulates, in the memory 56, data indicating the relationship between Q values and PE values (operation S26).

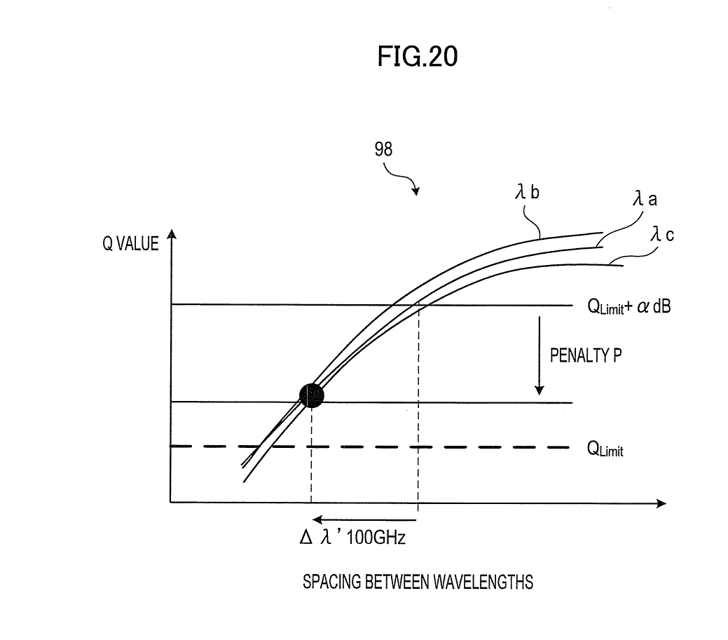

FIG. 20 illustrates an example of a relationship between Q values and wavelength spacings. As in a graph 98 illustrated in FIG. 20, when the spacing between wavelengths is narrowed, the Q value tends to decrease owing to nonlinear effects such as cross-phase modulation and/or optical four-wave mixing. By accumulating data indicating relationships between Q values and wavelength spacings, it is possible to measure a decrement of the Q value at the time when wavelength spacing is narrowed, as penalty P.

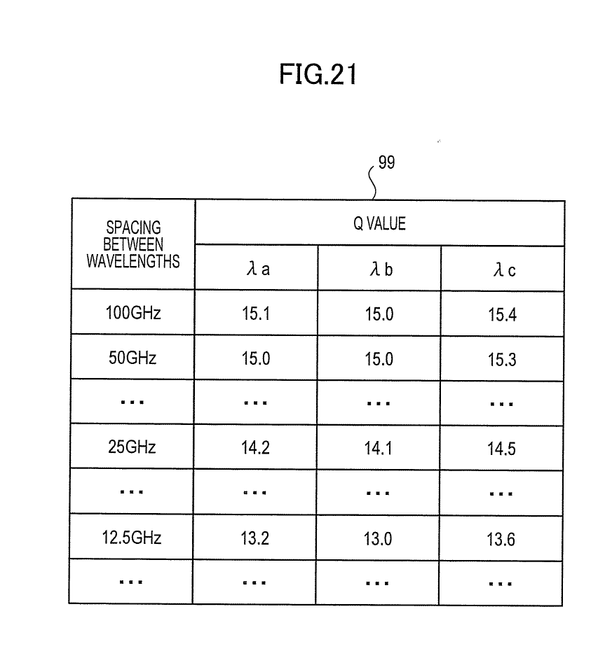

FIG. 21 is an example of measurement data 99 on relationship between Q values and wavelength spacings. By accumulating, in advance, data indicating relationships between Q values and wavelength spacings, the minimum spacing between wavelengths may be set within a range in which the Q value dose not become lower than the Q_{Limit}.

If the Q value attains the Q_{Limit} in course of measuring the Q value while narrowing the wavelength spacing, the wavelength spacing processing unit 68 fixes a wavelength at the wavelength spacing at that time. Then, the first optical transmission/reception apparatus 11 again measures the relationship between Q values and PE values by the optical intensity processing unit 67 (operation S27). The measurement at this time has only to be made to the point that the Q value becomes higher than the Q_{Limit} by a specified value, e.g., about 2 dB. By re-measuring the relationship between Q values and PE values, it is possible to measure the effect when the PE value has been adjusted at a state where as many wavelengths as possible are arranged with the spacing between wavelengths set to a minimum, that is, at a state where the transmission capacity of the optical communication system is a maximum. On the basis of data accumulated by the above-described measurement processing, the wavelength spacing processing unit 68, regarding blocks to be measured, may determine a lowermost value of PE value and a minimum wavelength-spacing such that the Q value becomes higher than a desired value (operation S28). Thus a series of measurement processing with respect to characteristics is completed.

The above-described arrangement processing of wavelengths and measurement processing of characteristic are effective even in a system in which wavelengths mutually different in modulation method or wavelengths mutually different in bit rate (10 Gb/s, 40 GB/s etc.) are mixed, since the arrangement of wavelengths is determined on the basis of a correlation between the Q value, the spacing between wavelengths, the dispersion, and the PE value. That is, even in a system in which mutually adjacent wavelengths, wavelengths mutually different in modulation method, or wavelengths mutually different in bit rate are mixed, it is possible to determine the minimum wavelength-spacing satisfying a desired Q value and to arrange wavelengths without dependence on the difference in modulation method or bit rate.

In the case where it is known in advance that mutually different modulation methods are mixed, when the above-described measurement processing of characteristic is performed, it is possible to determine the minimum wavelength-spacing for each modulation method in each block, by making wavelengths mutually different in modulation method adjacent to each other, as wavelengths for measurement. Furthermore, in the case where mutually different modulation methods are mixed during the operation of the system, the accumulated data is updated by again making the same measurement upon replacing a modulation method for the mutually adjacent wavelengths by respectively different modulation methods, on the basis of data indicating the relationship between the penalty P of a firstly measured Q value and wavelength spacing. On the basis of the updated data, it is possible to determine the minimum wavelength-spacing satisfying the desired Q value for each of the modulation method at the start of the operation of the system and the newly introduced modulation method.

According to the optical transmission apparatus, the optical communication method, and the optical communication system in some embodiments, the effect of allowing an increase in transmission capacity is produced. Furthermore, the effect of allowing setting the spacing between wavelengths in response to a system, is produced.

Moreover, in an embodiment, in the optical transmission/reception apparatuses 11 and 12, since all the transmission units 31 may be equally configured to each other, the number of the transmission units 31 to be prepared as a backup may be reduced. The same goes for the reception units 71, in which the number of the transmission units 31 to be prepared as a backup may be decreased as well.

A computer-implemented method includes returning state information of lights of from a receiver and adjusting or changing a spacing between mutually adjacent wavelengths of the lights that are transmitted to the receiver using the state information. According to an embodiment, adjusting may include changing a first spacing to a second spacing when the state information indicates a transmission quality value below a specified value, for example, based on a determination at operation S23 in FIG. 16.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention, the scope of which is defined in the claims and their equivalents.

What is claimed is:

1. An optical transmission apparatus, comprising:
transmission units configured to transmit lights having different wavelengths;
a multiplexing unit configured to multiplex the lights transmitted from the transmission units; and
a controller configured to control the wavelengths of the lights,
wherein the controller includes:
a wavelength spacing processing unit that controls a spacing between the wavelengths based on reception state information of an apparatus that has received the multiplexed light.

2. The optical transmission apparatus according to claim 1, wherein
the transmission unit includes:
a dispersion compensator that vary dispersion compensation amounts of the lights transmitted from the transmission units, and
the controller includes:
a dispersion compensation amount processing unit that controls the dispersion compensation amounts based on the reception state information.

3. The optical transmission apparatus according to claim 1, wherein
the transmission unit includes an optical attenuator that vary an intensity of light transmitted from the transmission unit; and
the controller includes an optical intensity processing unit that controls the optical attenuator based on the reception state information.

4. The optical transmission apparatus according to claim 1, wherein
the controller includes a band division processing unit that divides a band of light into bands; and
the wavelength spacing processing unit controls a spacing between mutually adjacent wavelengths of lights that are transmitted from the transmission units for each of the bands divided by the band division processing unit.

5. The optical transmission apparatus according to claim 4, wherein the band division processing unit divides the band into a central block, a block on a shorter wavelength side than the central block, and a block on a longer wavelength side than the central block.

6. The optical transmission apparatus according to claim 1, wherein the controller includes a wavelength arrangement processing unit that arranges the wavelengths based on a wavelength spacing determined by the wavelength spacing processing unit.

7. An optical communication method, comprising:
multiplexing lights having different wavelengths while varying the wavelengths of the lights, and transmitting the multiplexed light;
controlling the wavelengths of the lights, based on information notified of the transmitted light, by a apparatus that has received the light; and
arranging wavelengths based on the controlled wavelength spacing.

8. The optical communication method according to claim 7, comprising:
prior to multiplexing and transmitting the lights with different wavelengths while varying the wavelengths of the lights, multiplexing and transmitting the lights with different wavelengths while varying dispersion compensation amounts of the lights; and
controlling the dispersion compensation amount of the light based on the information notified of the light multiplexed and transmitted while varying the dispersion compensation amounts, by a apparatus that has received the light.

9. The optical communication method according to claim 8, wherein the control of the dispersion compensation amount of the light includes controlling a dispersion compensation of each of the apparatus that has transmitted the light and the apparatus that has received the light.

10. The optical communication method according to claim 8, comprising:
after having controlled the dispersion compensation amount of the light, multiplexing and transmitting the lights with mutually different wavelengths while varying intensities of the lights; and
controlling the intensity of the light beam based on the information notified of the transmitted light by a apparatus that has received the light.

11. An optical communication system, comprising:
an optical transmission apparatus;
an optical reception apparatus; and
an optical transmission path connecting the optical transmission apparatus and the optical reception apparatus, and
wherein the optical transmission apparatus includes:
transmission units capable of transmitting lights having mutually different wavelengths;
a multiplexing unit that multiplexes the lights transmitted from the transmission units; and
controller that controls a spacing between wavelengths of lights that are transmitted from the transmission units; and
wherein the controller includes:
a wavelength spacing processing unit that, while varying the spacing between wavelengths of lights that are transmitted from the transmission units, controls a spacing between mutually adjacent wavelengths of lights that are transmitted from the transmission units, based on the information notified of light multiplexed in the multiplexing unit by a apparatus that has received the light; and
wherein the optical reception apparatus divides the lights transmitted from the transmission units into lights having wavelengths, and after having detected a reception state when the lights are received for each of the wavelengths, notifies the optical transmission apparatus of the information concerning the reception state.

12. The optical communication system according to claim 11,
wherein the transmission units include dispersion compensators that vary dispersion compensation amounts of lights that are transmitted from the transmission units; and
wherein the controller includes a dispersion compensation amount processing unit that, while varying the dispersion compensation amounts of lights that are transmitted from the transmission units by the compensators, controls the dispersion compensation amounts of the lights that are transmitted from the transmission units, based on the information.

13. The optical communication system according to claim 11,
wherein the transmission units include optical attenuators that vary intensities of lights that are transmitted from the transmission units; and
wherein the controller includes an optical intensity processing unit that, while varying the intensities of lights that are transmitted from the transmission units, controls the intensities of the lights that are transmitted from the transmission units, based on the information.

14. The optical communication system according to claim 11,
wherein the controller includes a band division processing unit that divides a band of light into bands; and
wherein the wavelength spacing processing unit controls the spacing between mutually adjacent wavelengths of lights that are transmitted from the transmission units for each of the bands divided by the band division processing unit.

15. The optical communication system according to claim 14, wherein the band division processing unit divides the band into a central block, a block on a shorter wavelength side than the central block, and a block on a longer wavelength side than the central block.

16. The optical communication system according to claim 11, wherein the controller includes a wavelength arrangement processing unit that arranges wavelengths based on a wavelength spacing determined by the wavelength spacing processing unit.

17. A computer-implemented method, comprising:
returning state information of lights of from a receiver; and
adjusting a spacing between mutually adjacent wavelengths of the lights that are transmitted to the receiver using the state information.

18. The computer-implemented method according to claim 17, wherein said adjusting includes changing a first spacing to a second spacing as the state information indicates a transmission quality value below a specified value.
